(19) United States
(12) Patent Application Publication
(10) Pub. No.: US 2026/0124973 A1
(43) Pub. Date: May 7, 2026

(54) PROTECTION MODULE FOR LIMITING AND/OR BLOCKING A MOVEMENT BETWEEN TWO STRUCTURAL COMPONENTS AND/OR A SEAT FUNCTION OF A VEHICLE SEAT AND VEHICLE SEAT

(71) Applicant: Adient US LLC, Plymouth, MI (US)

(72) Inventors: Martin KONAK, Sklabina pri Martine (SK); Juraj BAGIN, Dubnica nad Váhom (SK); Martin HUDÁK, Adamovské Kochanovce (SK); Michal ANDO, Trencín (SK)

(21) Appl. No.: 19/380,123

(22) Filed: Nov. 5, 2025

(30) Foreign Application Priority Data
Nov. 6, 2024 (DE) 10 2024 210 665.8

(51) Int. Cl. B60N 2/42

(52) U.S. Cl. CPC B60N 2/4249

(57) ABSTRACT

A protection module for limiting and/or blocking a movement between at least two structural parts and/or a seat function of a vehicle seat in the event of a crash or during normal use may have one control unit, one protection unit and one coupling element arranged between the control unit and the protection unit. The coupling element may be formed to be variable in its length and couples the control unit and the protection unit to one another in such a way that a movement of the control unit can be transmitted to the protection unit. An adjustable vehicle seat may use the protection module.

### FIELD

The invention relates to a protection module for limiting and/or blocking a movement between two structural parts and/or a seat function of a vehicle seat in the event of a crash or during normal use, as well as a vehicle seat with at least two structural parts and such a protection module.

### BACKGROUND

An adjustment unit for a vehicle seat is known from DE 10 2023 132 496 A1, wherein the adjustment unit has a rotary lever coupled to a floor lock of the vehicle seat, wherein the rotary lever is movable between a first rotary lever position and a second rotary lever position, wherein the adjustment unit has a blocking device coupled to a seat adjustment fitting of the vehicle seat, which is movable between a first position when a backrest of the vehicle seat is arranged in a usage position, and a second position when the backrest is arranged in a non-usage position, wherein the blocking device prevents or releases a transfer of the rotary lever from the first rotary lever position to the second rotary lever position.

The object on which the invention is based is to indicate a novel protection module for limiting and/or blocking a movement between two structural parts and/or a seat function of a vehicle seat in the event of a crash or during normal use, in particular a modular system for vehicle seats of different block heights and for vehicle seats with structural parts that are to be limited and/or blocked relative to or against each other, as well as a corresponding vehicle seat.

### SUMMARY

With regard to the protection module, the object is achieved according to the invention by the features indicated in claim 1. With regard to the vehicle seat, the object is achieved according to the invention by the features indicated in claim 11.

Advantageous configurations, which can be used individually or in combination with each other, are the subject matter of the subordinate claims.

The object is achieved according to the invention by a protection module for limiting and/or blocking a movement between two structural parts and/or a seat function of a vehicle seat in the event of a crash or during normal use, wherein the protection module comprises at least one control unit, one protection unit and one coupling element arranged between the control unit and the protection unit, which coupling element is formed to be variable in its length and couples the control unit and the protection unit to one another in such a way that a movement of the control unit can be transmitted to the protection unit.

Due to the fact that the protection module comprises at least one control unit, one protection unit, and one coupling element arranged between the control unit and the protection unit, a fully functional protection module can be formed from only a few components. The protection module can be easily adapted to different conditions, for example, limiting conditions and/or blocking conditions, as well as to limit and/or block a movement of different structural parts relative to one another in the event of a crash or during normal use. Furthermore, a protection module composed of the above-mentioned components can be adapted to differently formed vehicle seats, for example, with different so-called block heights of a seat substructure, with different seat frame parts, seat structural parts, and/or seat functions. In particular, the protection module can be formed to be compact and with reduced costs.

Due to the fact that the coupling element is formed to be variable in length and couples the control unit and the protection unit in such a way that a movement of the control unit can be transmitted to the protection unit, various functions, such as limiting functions and/or blocking functions, can be realized with just one protection module. Such a protection module can be integrated into vehicle seats of different forms and/or into vehicle seats with different structural parts, seat frame parts, and/or installation heights. It should be understood that such a protection module is not limited to use in vehicle seats.

The protection module can be easily retrofitted and/or pre-assembled as an add-on module. The protection module can support, for example, reinforce functions of already installed seat adjustment units. The protection module can be retrofitted, installed, and removed without affecting existing structural components and/or seat functions. An integration of the protection module can be retrofitted, assembled and disassembled without affecting existing structural parts and/or seat functions. The protection module can be a plug-in module which can be retrofitted and/or pre-assembled. The protection module can be a so-called “plug-and-play” module. The protection module offers the possibility of integrating an additional protection device, such as a locking device, if required, at any location on the vehicle seat, regardless of the seat structure and block height. The protection module can be formed as a modular system that is identical for all vehicle platforms.

The control unit, the protection unit, and the coupling element can be coupled to one another in such a way that, upon a first movement of the control unit, a further movement of the control unit relative to the protection unit is limited and/or blocked. The control unit can be assigned to a structural part, in particular fastened to it, which can deform and/or distort in the event of a crash, wherein a deformation and/or distortion of the structural part causes a movement of the control unit in the deformation direction and/or distortion direction. To prevent the structural part from deforming and/or distorting further in the deformation direction and/or distortion direction, the protection unit can be actuated by transmitting movement via the coupling element and blocking further movement in the deformation direction and/or distortion direction of the control unit and thus of the structural part. In a further development, the protection unit can additionally engage with a rocker of a height adjuster and/or tilt adjuster of the seat by transmitting movement via the coupling element, so that a movement of the rocker relative to the structural part is limited and/or blocked in the event of a crash. This prevents the rocker, which can be pivotably mounted on the structural part, for example, on a seat frame side part, from buckling in the event of a crash.

The control unit and the coupling element can be actuated by a change in distance between the control unit and the protection unit. For example, the coupling element can be actuatable by a linear movement, for example, linear displacement of the control unit relative to the protection unit, for example, perpendicular to a protection axis of the protection unit.

The control unit and the coupling element can be actuatable by a rotation, for example, a rotation, pivoting, or tilting, of the control unit about a control axis. For example, the coupling element can be actuatable by a rotary movement about a control axis. The control axis and the protection axis can be aligned parallel. The protection unit can be movable between a starting position and a protection position. Actuation of the coupling element can trigger a position change of the protection unit.

When the control unit moves, the protection unit can be controlled via the coupling element to limit and/or block a movement between the structural part and the rocker, as well as a height adjustment function and/or tilt adjustment function. A movement of the control unit can lead to a force transmission via the coupling element, which, for example, causes an actuation and/or movement of the protection unit, so that the protection unit and the control unit can be locked against each other.

The control unit can be rigidly fastened to the structural part. The protection unit can be formed to be movable between a starting position, in particular the normal or non-usage position, and a protection position in which the protection unit is engaged with at least one structural part, in particular a limiting engagement and/or blocking engagement. The protection module can be used in metal structures and plastic structures in which at least one kinematic movement and/or deformation movement is present.

In one exemplary embodiment, the control unit can be formed to be movable between a starting position, in particular a normal position or non-usage position, and a control position. In the control position, the control unit can cause an actuation of the coupling element. The protection unit can be formed to be movable between a starting position and a protection position, for example, a blocking position and/or limiting position. The coupling element can couple the control unit and the protection unit to one another in such a way that a movement of the control unit from the starting position to the control position causes a movement of the protection unit from the starting position to the protection position, wherein, in the protection position, the protection unit limits and/or blocks, for example, disables, a movement between two structural parts and/or a seat function of a vehicle seat.

The protection module can comprise a locking mechanism that blocks the movement of a seat structural part by the protection unit based on the activation provided by the control unit. The protection unit can be a locking unit. The coupling element can be a tension element, in particular a Bowden cable, or another force-transmitting element. The control unit and the locking unit can be connected via a Bowden cable.

The protection module can be used, for example, as a locking module to secure the seats of a second or third row in an easy-entry position, wherein the same protection module can also be used for seats with different block heights on a platform of different vehicles.

The control unit can be formed to be modular. The protection unit can be formed to be modular. As a result, these units can be mounted as simple plug-in elements on different structures when needed and removed when not needed. The control unit can have at least one first coupling point for connecting to a first end of the coupling element. The protection unit can have at least one second coupling point for connecting to a second end of the coupling element.

The control unit can comprise a multiplicity of control elements. The protection unit can comprise a multiplicity of protection elements.

Depending on the condition and/or configuration of the seat structures or the vehicle seat and depending on the seat function, the number, dimensions and/or shape of the control elements and/or protection elements can be variably adjusted.

Individual control elements and individual protection elements can be formed as identical parts.

In one embodiment, the protection module for limiting and/or blocking a movement between two structural parts and/or a seat function of a vehicle seat in the event of a crash or during normal use can comprise at least one control unit rotatable about a first axis, one protection unit rotatable about a second axis, and one coupling element arranged between the control unit and the protection unit. The coupling element can be formed to be variable in length and can couple the control unit and the protection unit to one another in such a way that a rotation of the control unit about the first axis causes a rotation of the protection unit about the second axis.

In the case of a multiplicity of control elements, these can be arranged coaxially on a control axis. The control unit can comprise, as control elements, at least one rotary shaft, one control lever pivotably mounted on the rotary shaft, and one spring element. The spring element can be a restoring element. In the case of a multiplicity of protection elements, these can be arranged coaxially on a protection axis. The protection unit can comprise, as protection elements, at least one rotary shaft, one protection lever pivotably arranged on the rotary shaft, and one spring element. The spring element can be a restoring element. The control unit and the protection unit can be detachably fastened to the structure using various connection techniques, for example, rivets and/or screws. If a protection module is installed, it can be easily removed, leaving the seat structure and/or the vehicle seat unchanged. The protection module can then be further used or reused. A non-detachable connection is not excluded.

The modularity of the protection module offers the possibility of being assembled in so-called JIT systems (Just-In-Time systems) and reducing the number of end pieces in systems.

The object is furthermore achieved according to the invention by a vehicle seat, comprising at least one first structural part, one second structural part movable relative to the first structural part during normal use or in the event of a crash and at least one protection module for limiting and/or blocking a movement between the two structural parts and/or a seat function during normal use or in the event of a crash. Movement is understood to mean, for example, both an adjustment movement between two structural parts for adjusting a seat function, for example, during normal use or normal operation, as well as a deformation and/or distortion of a structural part, for example, in the event of a crash. The protection module comprises at least one control unit, one protection unit, and one coupling element arranged between the control unit and the protection unit, which is formed to be variable in length. The control unit is assigned to the first structural part. The protection unit is assigned to the second structural part. The coupling element is arranged between the control unit and the protection unit and thus between the first structural part and the second structural part, wherein the coupling element couples the control unit and the protection unit to one another in such a way that a second movement of the control unit triggered by a first movement of the first structural part can be transmitted to the protection unit and the second structural part.

The first movement of the seat structural part can be an adjustment movement or distortion movement or deformation movement. In particular, the first movement can correspond to a linear movement. The second movement of the control unit can be a pivoting movement and/or a pushing movement.

The first movement of the first structural part actuates the control unit, wherein the coupling element exerts a tensile force on the protection unit and actuates the protection unit to limit and/or block a third movement of the second structural part. The third movement can be a pivoting movement and/or a pushing movement. The protection unit can perform a fourth movement, for example, a pivoting movement and/or a pushing movement, in particular a blocking movement and/or limiting movement.

The control unit can be configured to be actuatable or to be actuated by a first, for example, linear movement of the first structural part. Upon actuation of the control unit, the coupling element can trigger an actuation of the protection unit, wherein the protection unit is configured to limit, block, or disable a third movement, for example, a rotational movement of the second structural part. In the event of a crash, the control unit can be actuated by a deformation and/or distortion of the first structural part, and during normal use by an adjustment movement of the first structural part. At least one of the structural parts can be a rocker, a seat frame side part, a crossbar, a drive unit, a fitting, or a rail element.

In summary, and in other words, the invention provides a modular and multifunctional protection device that can be used to improve various adjustment units, such as a backrest adjustment, easy-entry seat adjustment, seat height adjustment, seat tilt adjustment, thigh support adjustment, and to improve various protection functions, such as limiting the deformation of a seat surface part, a backrest part, and/or a rocker in the event of a crash.

### DESCRIPTION OF THE FIGURES

The invention is explained in greater detail below on the basis of advantageous exemplary embodiments represented in the figures. However, the invention is not limited to these exemplary embodiments. In the figures:

FIG. 1: shows, in a schematic representation, a vehicle seat with a longitudinal adjustment device, wherein the vehicle seat is provided with a multiplicity of protection modules according to the invention for limiting and/or blocking a movement between two structural parts and/or a seat function of the vehicle seat,

FIG. 2: shows schematically a protection module according to the invention according to a first exemplary embodiment,

FIG. 3: shows schematically, in a perspective view, a vehicle seat with a first block height, wherein the vehicle seat is provided with a protection module according to the invention according to FIG. 2,

FIG. 4: shows schematically, in a perspective view, a vehicle seat with a second block height, wherein the vehicle seat is provided with a protection module according to the invention according to FIG. 2,

FIG. 5: shows schematically an exploded representation of a protection module according to the invention according to a second exemplary embodiment,

FIG. 6: shows schematically a side view of a vehicle seat with a first block height and a protection module according to FIG. 5,

FIG. 7: shows schematically a side view of a vehicle seat with a second block height and a protection module according to FIG. 5,

FIGS. 8 to 11: show schematically, in side views, a movement sequence in which the vehicle seat according to FIG. 6 is moved from a design position to an easy-entry position,

FIGS. 12 to 14: show schematically, in side views, a movement sequence in which a protection unit of the protection module is moved between a starting position and a protection position,

FIG. 15: shows schematically, in a perspective view, a vehicle seat with a tilt adjustment unit and a protection module according to the invention according to a third exemplary embodiment,

FIG. 16: shows schematically, in a perspective view, a leg support device for a vehicle seat, wherein the leg support device is provided with a protection module according to the invention according to a fourth exemplary embodiment, and

FIG. 17: shows schematically, in a perspective view, a vehicle seat with a protection module according to the invention according to a fifth exemplary embodiment.

### DETAILED DESCRIPTION

Corresponding parts are provided with the same reference signs in all figures.

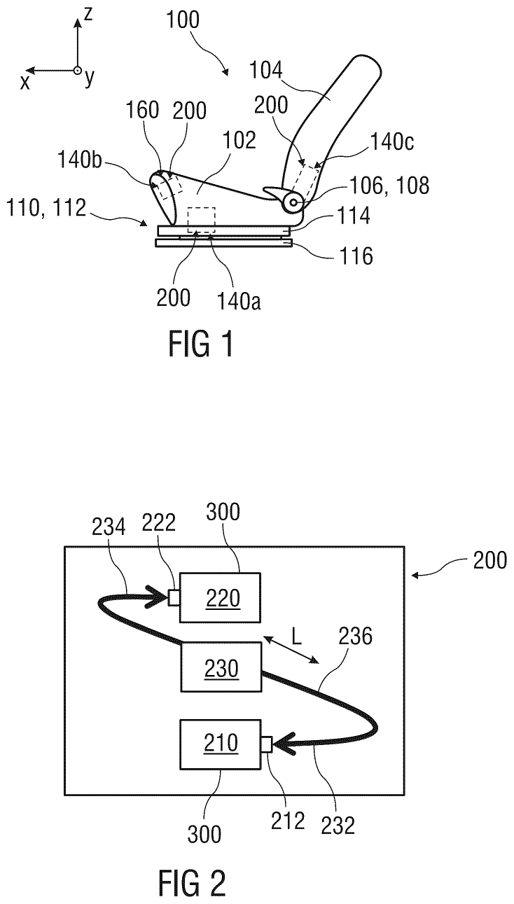

A vehicle seat 100, schematically represented in FIG. 1, is described below using three spatial directions running perpendicular to one another. A longitudinal direction x, in a vehicle seat 100 installed in the vehicle, runs largely horizontally and preferably parallel to a vehicle longitudinal direction that corresponds to the usual direction of travel of the vehicle. A transverse direction y, running perpendicular to the longitudinal direction x, is also oriented horizontally in the vehicle and runs parallel to a vehicle transverse direction. A vertical direction z runs perpendicular to the longitudinal direction x and perpendicular to the transverse direction y. In a vehicle seat 100 installed in the vehicle, the vertical direction z preferably runs parallel to a vehicle vertical axis.

The position and direction indications used, such as front, rear, top, and bottom, refer to the viewing direction of an occupant sitting in the vehicle seat 100 in a normal seating position, wherein the vehicle seat 100 is installed in the vehicle, in a usage position suitable for passenger transport with the backrest 104 upright and oriented in the direction of travel as usual. However, the vehicle seat 100 can also be installed or moved in a different orientation, for example, transversely to the direction of travel. Unless otherwise described, the vehicle seat 100 is constructed mirror-symmetrically to a plane that runs perpendicular to the transverse direction y.

The backrest 104 can be pivotably mounted on a seat part 102 of the vehicle seat 100. For this purpose, the vehicle seat 100 can optionally include a fitting 106, in particular an adjustment fitting, rotary fitting, locking fitting, or wobble fitting.

The position and direction indications used, such as radial, axial and in the circumferential direction, refer to an axis of rotation 108 of the fitting 106. Radial means perpendicular to the axis of rotation 108. Axial means in the direction of or parallel to the axis of rotation 108.

The vehicle seat 100 can optionally comprise a longitudinal adjustment device 110. The longitudinal adjustment device 110 comprises, for example, a rail arrangement 112 with a first rail element 114 and a second rail element 116. The first rail element 114 is adjustable relative to the second rail element 116 in the longitudinal direction x. The first rail element 114 is fastened to the seat part 102. The second rail element 116 is attached to a structural element of a vehicle, for example, a vehicle floor.

For the sake of improved clarity, the first rail element 114 is referred to as the upper rail 114 in the following description. This upper rail 114 (also called a running rail or slide) is assigned to the vehicle seat 100 and is configured to support this vehicle seat 100. The second rail element 116 is referred to below as the lower rail 116. The lower rail 116 is fixed and connected, for example, to the floor of a vehicle.

The vehicle seat 100 can be provided with a multiplicity of protection modules 200 according to the invention for limiting and/or blocking a movement between two structural parts 120, 122 (represented in greater detail in the following figures) and/or a seat function 140a to 140c of the vehicle seat 100.

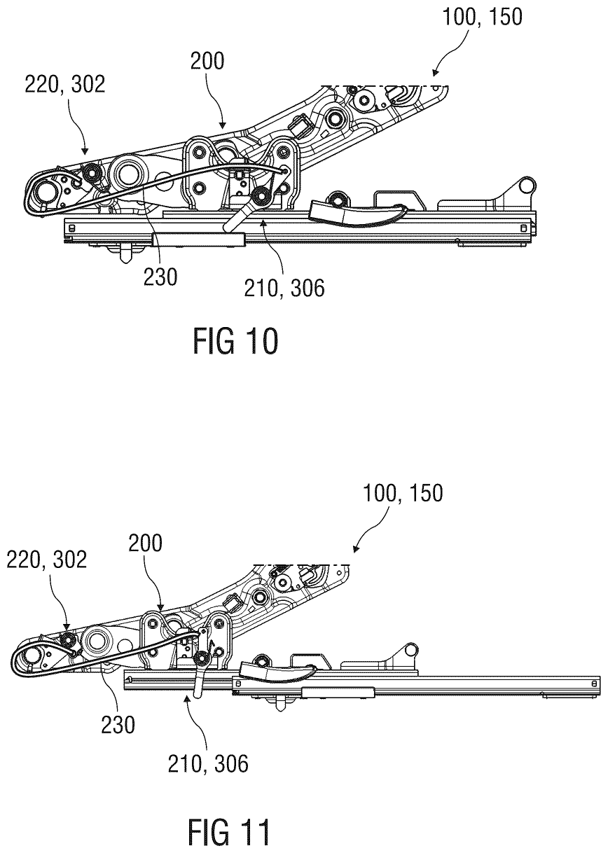

For example, a first protection module 200 can couple the longitudinal adjustment device 110 and the seat part 102 to one another and be configured to limit and/or block an easy-entry function (also referred to as a pitch-lock function) of the vehicle seat 100 as a first seat function 140a. This can prevent, for example, the release of the seat part 102 when the seat part 102 is pivoted forward for easier access to a rear row of seats, as long as the vehicle seat 100 is shifted into a longitudinal position corresponding to an easy-entry position 150 (see FIGS. 9 to 11). Even in the event of a crash and in the presence of crash loads, the protection module 200 can absorb a force acting on the seat part 102 and the corresponding adjustment unit.

For example, a second protection module 200 can be arranged in the region of a leg support device 160 of the vehicle seat 100 and configured to limit and/or block a leg support function of the leg support device 160 as a second seat function 140b. This can limit and/or block an unwanted further adjustment of the leg support device 160, for example, under load, relative to the seat part 102.

For example, a third protection module 200 can couple the backrest 104 and the fitting 106 to one another and be configured to limit and/or block a backrest pivoting function of the backrest 104 as a third seating function 140c. In the event of a crash or when crash loads act on the backrest 104, a force can be transmitted to the backrest 104 via the protection module 200, the fitting 106, the seat part 102, and possibly the seat rails into the vehicle body. The coupling means and the displaceable cushion support of the seat part 102 are not subjected to these crash forces, or are subjected to only a slight impact, and can thus be designed to be lightweight and low-cost.

Further protection modules 200 can be provided at any location on the vehicle seat 100. The number of protection modules 200 can vary.

The respective protection module 200 is, in particular, an add-on module that can be retrofitted and/or pre-assembled and that can additionally support already installed adjustment systems and/or seat functions 140a to 140c. Due to the modularity of the respective protection module 200, it can be easily retrofitted, but also removed again, without affecting or impairing the vehicle seat 100, the adjustment systems and/or seat functions 140a to 140c.

In particular, the respective protection module 200 is a multifunctional module for limiting and/or blocking and/or disabling various parts and functions of the vehicle seat 100.

FIG. 2 shows schematically a protection module 200 according to the invention according to a first exemplary embodiment.

The protection module 200 for limiting and/or blocking a movement between two structural parts 120, 122 (represented in greater detail in the following figures) and/or a seat function 140a to 140c of a vehicle seat 100 in the event of a crash or during normal use comprises at least one control unit 210, one protection unit 220 and one coupling element 230 arranged between the control unit 210 and the protection unit 220.

The coupling element 230 is formed to be variable in its length L. The coupling element 230 can be a force transmission element, in particular a traction means and/or a Bowden cable 236. The control unit 210 and the protection unit 220 are coupled to one another via the coupling element 230 such that a movement of the control unit 210 can be transmitted to the protection unit 220 in order to limit, block, and/or disable a movement between the structural parts 120, 122 and/or a seat function 140a to 140c.

The control unit 210, the protection unit 220 and the coupling element 230 are coupled to one another in such a way that, during a first movement of the control unit 210, a further movement of the control unit 210 relative to the protection unit 220 is limited and/or blocked.

According to one exemplary embodiment, a movement of the control unit 210 can cause a movement of the protection unit 220. The coupling element 230 can clamp the control unit 210 and the protection unit 220 against each other.

The protection module 200 is, in particular, a plug-in module that can be retrofitted and/or pre-assembled. The protection module 200 can be a so-called “plug-and-play” module. The protection module 200 offers the possibility of integrating an additional protection device, for example, a locking device, at any location on the vehicle seat 100, if necessary, regardless of the seat structure, seat design, and seat height. The protection module 200 can be a cross-platform modular system.

The control unit 210 and/or the protection unit 220 can be formed to be modular. This simplifies assembly of the protection module 200. The control unit 210 has at least one first coupling point 212 for connection to a first end 232 of the coupling element 230. The protection unit 220 has at least one second coupling point 222 for connection to a second end 234 of the coupling element 230. When tension is exerted on the coupling element 230 by a movement of the control unit 210, this tension is transmitted via the coupling element 230 to the protection unit 220, wherein the protection unit 220 can be actuated.

The control unit 210 can be formed to be movable, for example, linearly movable or pivotably movable. The control unit 210 can be formed to be indirectly movable. For example, the control unit 210 can be connected to one of the structural parts 120, 122 such that a movement of the structural part 120, 122 also moves the control unit 210. The control unit 210 can be formed to be directly movable, wherein the control unit 210 is movable relative to the structural part 120, 122. A movement of the structural part 120, 122 can cause a movement of the control unit 210.

The protection unit 220 is configured to limit and/or block the movement between two structural parts 120, 122 and/or the seat function 140a to 140c. For this purpose, the protection unit 220 can be formed to be movable, for example, pivotably movable or linearly movable. The protection unit 220 can, for example, be arranged on the other of the structural parts 120, 122 and be formed to be movable relative to this structural part 120, 122.

The control unit 210 and the protection unit 220 can be reset to a starting position 300 using suitable restoring means.

The coupling element 230 can be movably arranged between the control unit 210 and the protection unit 220.

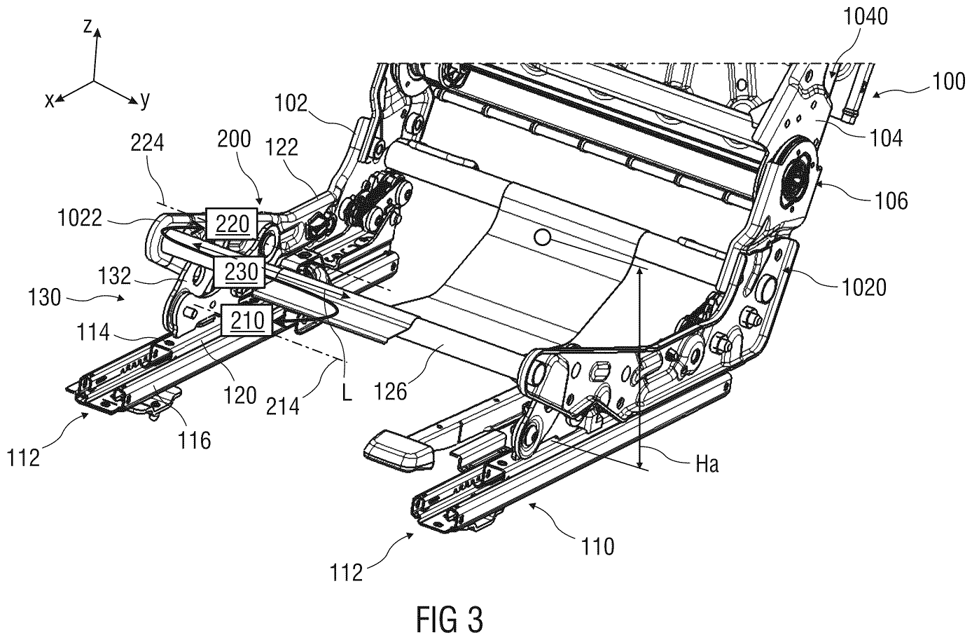

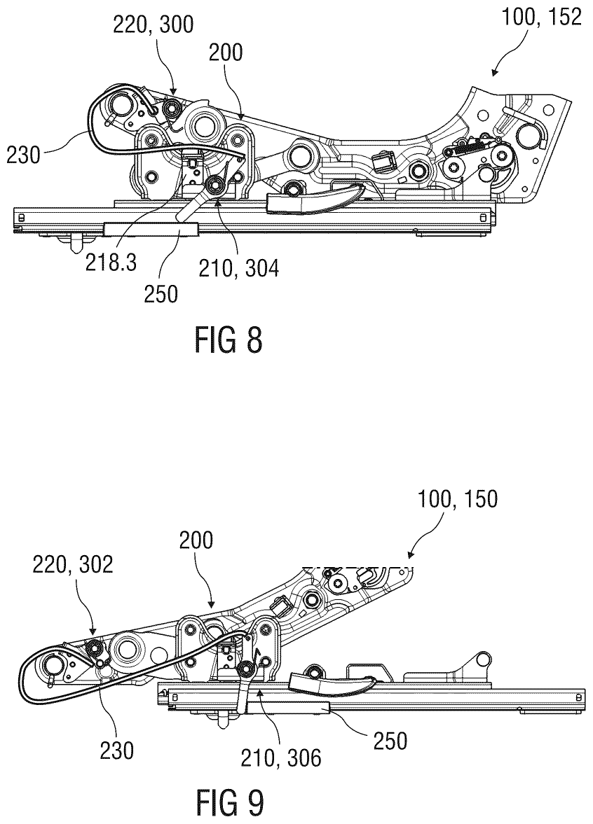

The control unit 210 and the coupling element 230 can be actuated by a change in distance between the control unit 210 and the protection unit 220. The change in distance can cause a tensile force triggered by the control unit 210 at the first end 232 of the coupling element 230. The tensile force is transmitted to the protection unit 220 via the coupling element 230, for example, the Bowden cable 236, and the second end 234 of the coupling element 230, whereby the protection unit 220 can be actuated. Alternatively or optionally additionally, the control unit 210 and the coupling element 230 can be actuated by a rotational movement of the control unit 210 about a control axis 214 (shown in FIG. 3). The protection unit 220 can be movable between a starting position 300 (shown in FIG. 8) and a protection position 302 (shown in FIGS. 9 to 11). For example, the protection unit 220 can be rotatably movable about a protection axis 224 (shown in FIG. 3). The control axis 214 and the protection axis 224 can run parallel to a vehicle transverse axis.

FIG. 3 shows schematically, in a perspective view, a vehicle seat 100 with a first block height Ha, wherein the vehicle seat 100 is provided with a protection module 200 according to the invention according to FIG. 2. The first block height Ha of a seat base of the vehicle seat 100 can, for example, be up to 200 mm.

The vehicle seat 100 comprises at least one first structural part 120, one second structural part 122 movable relative to the first structural part 120, and at least one protection module 200 for limiting and/or blocking a movement between the two structural parts 120, 122 of the vehicle seat 100 during normal use. The protection module 200 comprises at least one control unit 210, one protection unit 220, and one coupling element 230 arranged between the control unit 210 and the protection unit 220, which coupling element 230 is formed to be variable in length L and couples the control unit 210 and the protection unit 220 to one another in such a way that a movement of the control unit 210 can be transmitted to the protection unit 220.

The control unit 210 is assigned to the first structural part 120. In particular, the control unit 210 is arranged on and fastened to the first structural part 120. The protection unit 220 is assigned to the second structural part 122. The protection unit 220 is arranged on and fastened to the second structural part 122. The protection module 200, in particular the control unit 210, the protection unit 220, and the coupling element 230, can be fastened to the respective structure by simple riveting and/or screwing.

The seat part 102 comprises a seat part frame 1020. The backrest 104 comprises a backrest frame 1040. The protection unit 220 can be actuated such that it interacts with a third structural part 124, for example, a rocker 132 of a height and/or tilt adjustment device 130, which is movably mounted on the second structural part 122. The first structural part 120 can be a rail element 114, for example, an upper rail 114, or a rocker mount arranged on the rail element 114. The second structural part 122 can be a seat frame side part 1022 of the seat part frame 1020. In a further development, a further protection module 200 can be arranged on the backrest frame 1040 in order to limit and/or block movement between the backrest frame 1040 and the fitting 106.

In the represented exemplary embodiment, the coupling element 230 is guided in sections along a fourth structural part 126. The coupling element 230 couples the control unit 210 and the protection unit 220 to one another in such a way that a second movement of the control unit 210 triggered by a first movement of the first structural part 120 can be transmitted to the protection unit 220 and the second structural part 122.

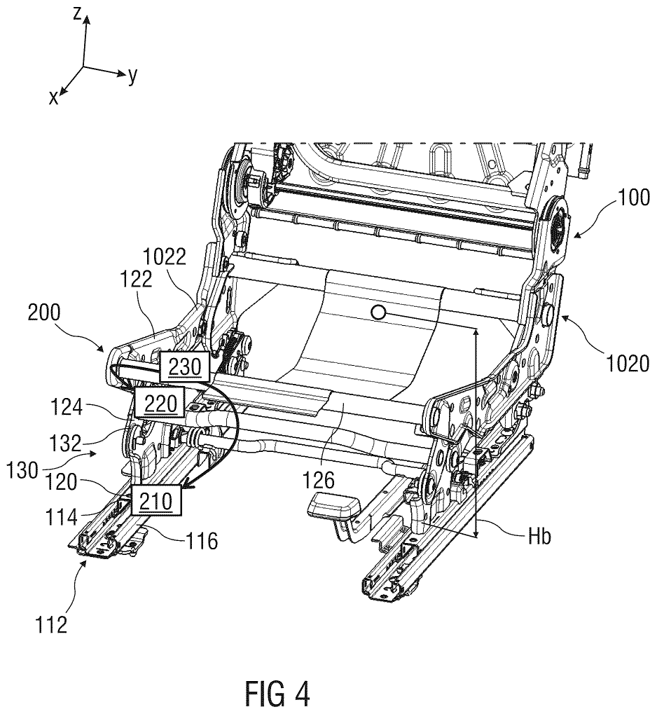

FIG. 4 shows schematically, in a perspective view, a vehicle seat 100 with a second block height Hb, wherein the vehicle seat 100 is provided with a protection module 200 according to the invention according to FIG. 2 and analogous to FIG. 3. For a so-called “pitch lock function” for securing the vehicle seat 100 in the easy-entry position 150 (shown in FIGS. 9 to 11), the same protection module 200 can be used for different vehicle platforms. The second block height Hb can, for example, be from 200 mm to 300 mm.

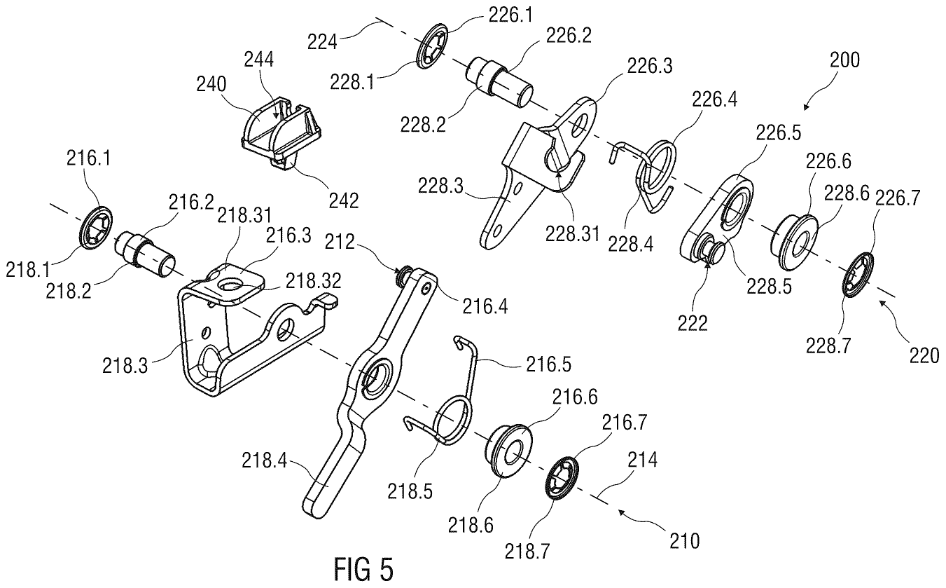

FIG. 5 shows schematically an exploded representation of a protection module 200 according to the invention according to a second exemplary embodiment.

In the represented exemplary embodiment, the control unit 210 comprises a multiplicity of control elements 216.1 to 216.7. The protection unit 220 comprises a multiplicity of protection elements 226.1 to 226.7. The individual control elements 216.1 to 216.7 and individual protection elements 226.1 to 226.7 can be formed as identical parts and thus be realized in a low-cost manner.

The control elements 216.1 to 216.7 are arranged coaxially on a control axis 214. The control unit 210 comprises, as control elements 216.1 to 216.7, at least one rotary shaft 218.2, one control lever 218.4 pivotably arranged on the rotary shaft 218.2, and a spring element 218.5. Furthermore, the control unit 210 can comprise, as further control elements 216.1 to 216.7, at least washers 218.1, 218.7, a spacer bushing 218.6, for example, made of plastic, and a control lever support 218.3.

The protection elements 226.1 to 226.7 are arranged coaxially on a protection axis 224. The protection unit 220 comprises, as protection elements 226.1 to 226.7, at least one rotary shaft 228.2, one protection lever 228.5 pivotably arranged on the rotary shaft 228.2, and a spring element 228.4. Furthermore, the protection unit 220 can comprise, as further protection elements 226.1 to 226.7, at least washers 228.1, 228.7, a spacer bushing 228.6, and a protection lever carrier 228.3. The protection lever carrier 228.3 can comprise at least one guide opening 228.31 for guiding the coupling element 230. The protection lever 228.5 has the second coupling point 222 for coupling with the second end 234 of the coupling element 230.

The protection module 200 can additionally comprise at least one holding element 240 for the coupling element 230. The control lever support 218.3 can have a connecting leg 218.31 with, for example, a connecting opening 218.32. The holding element 240 can be inserted and fastened with a corresponding holding arm 242 into the connecting opening 218.32 on the connecting leg 218.31 of the control lever support 218.3. The holding element 240 further has a holding guide 244 for guiding the coupling element 230 through.

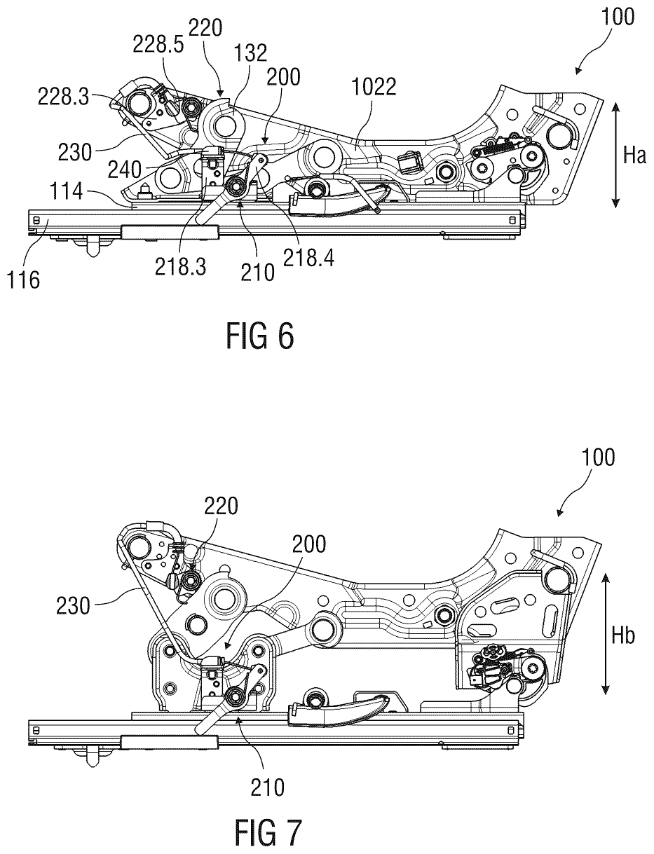

FIG. 6 shows schematically a side view of a vehicle seat 100 with a first block height Ha and a protection module 200 according to FIG. 5. FIG. 7 shows schematically a side view of a vehicle seat 100 with a second block height Hb and a protection module 200 according to FIG. 5. The fastening to corresponding structural parts 120 to 124 is analogous to the exemplary embodiment according to FIGS. 3 and 4. The control unit 210 and the protection unit 220, for example, in the form of a locking unit, are independent assemblies that can be used between several block heights Ha, Hb. The fastening to the seat part frame 1020 is carried out, for example, by blind rivets. The function of the protection module 200 is independent and can be added and removed without affecting other assemblies of the vehicle seat 100. The control unit 210 is fastened to the upper rail 114. For example, the control lever carrier 218.3 is mounted on the upper rail 114. The control lever 218.4 is pivotably mounted on the control lever support 218.3. The protection unit 220 is fastened to the seat frame side part 1022. For example, the protection lever support 228.3 is mounted on the seat frame side part 1022. The protection lever 228.5 is pivotably mounted on the protection lever support 218.3.

FIGS. 8 to 11 show schematically, in side views, a movement sequence in which the vehicle seat 100 according to FIG. 6 is moved from a design position 152 (FIG. 8) into an easy-entry position 150 (FIGS. 9 to 11). The first movement is a linear movement of the upper rail 114 relative to the lower rail 116. The first movement of the first structural part 120 can actuate the control unit 210, wherein the coupling element 230 exerts a tensile force on the protection unit 220 and actuates the protection unit 220 to limit and/or block a third movement of the second structural part 122 and optionally additionally a movement of the third structural part 124. The control unit 210 is formed to be movable between a starting position 304 (FIG. 8), in particular a normal or non-usage position, and a control position 306 (FIGS. 9 to 11). A stop element 250 arranged on the vehicle floor and/or on the lower rail 116 can be provided to actuate the control unit 210. The stop element 250 can initiate or block a pivoting movement of the control lever 218.4. When the vehicle seat 100 is transferred from a rear longitudinal position to a front longitudinal position, the control unit 210 can come into contact with or out of contact with the stop element 250, thereby triggering a pivoting movement of the control lever 218.4. In the control position 306, the control unit 210 can actuate the coupling element 230. The protection unit 220 is formed to be movable between a starting position 300 and a protection position 302, for example, a blocking position and/or limiting position. The coupling element 230 can couple the control unit 210 and the protection unit 220 to one another in such a way that a movement of the control unit 210 from the starting position 304 into the control position 306 causes a movement of the protection unit 220 from the starting position 300 into the protection position 302, wherein, in the protection position 302, the protection unit 220 limits and/or blocks, for example, disables a movement between at least two structural parts 120 to 124 and/or a seat function 140a to 140c of a vehicle seat 100.

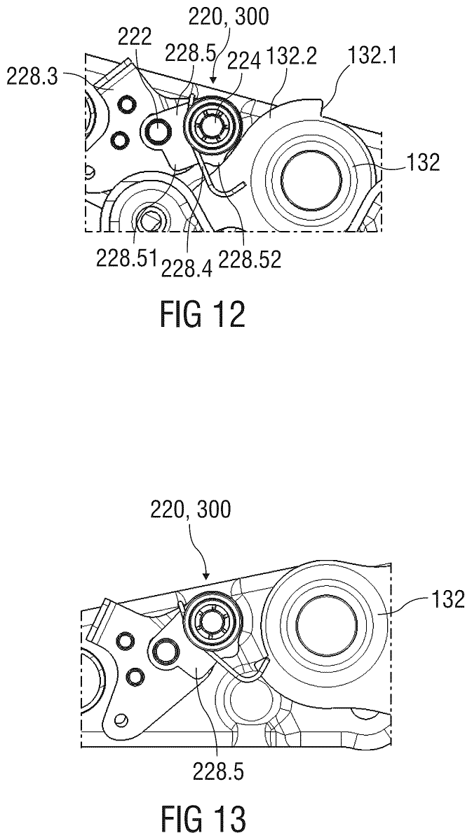

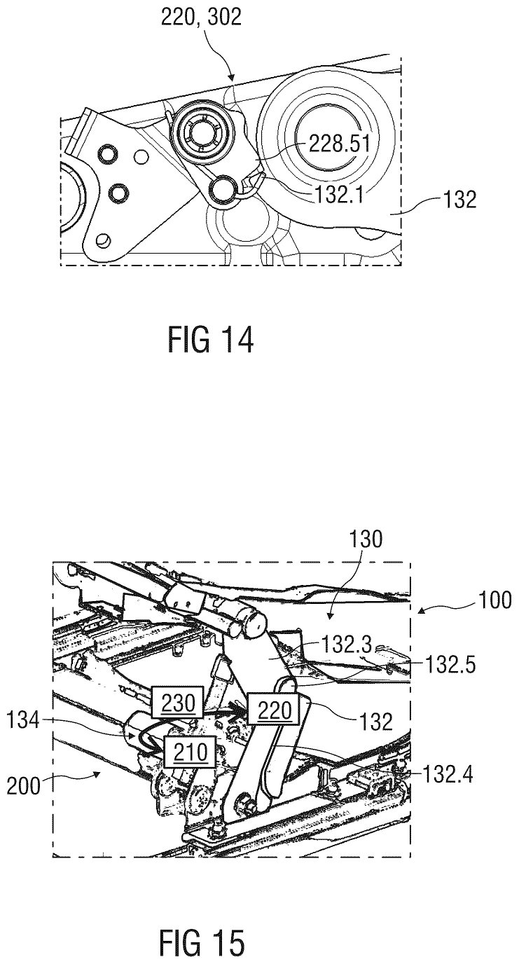

FIGS. 12 to 14 show schematically, in side views, a movement sequence in which a protection unit 220 of the protection module 200 is moved between a starting position 300 (FIGS. 12 and 13) and a protection position 302 (FIG. 14). The protection unit 220 can engage with a rocker 132 of a height adjuster and/or tilt adjuster of the seat through the movement transmission via the coupling element 230, so that a movement of the rocker 132 relative to the corresponding structural part 120 to 124 is limited and/or blocked in the event of a crash. As a result, the rocker 132, which can be pivotably mounted on the structural part 120 to 124, for example, on a seat frame side part 1022, cannot buckle in the event of a crash.

The rocker 132 comprises, for example, at least one locking contour 132.1 at a rocker end associated with the protection lever 228.5. The protection lever 228.5 comprises at least one counter-locking contour, in particular a locking lug 228.51. During normal operation of the height and/or inclination adjustment of the vehicle seat 100, the protection lever 228.5 can slide along an outer contour 132.2 of the rocker 132 with a sliding contour 228.52 (FIG. 12). In the protection position 302 (FIG. 14), the locking contour 132.1 of the rocker 132 and the locking lug 228.51 engage. This blocks further movement of the rocker 132.

FIG. 15 shows schematically, in a perspective view, a vehicle seat 100 with a tilt adjustment device 130 and a protection module 200 according to the invention according to a third exemplary embodiment.

The rocker 132 of the tilt adjustment device 130 comprises, for example, a first rocker element 132.3 and a second rocker element 132.4, which are connected to one another via a rocker joint 132.5. The tilt adjustment device 130 comprises at least one spindle drive unit 134 for adjusting the rocker elements 132.3, 132.4 relative to one another about the rocker joint 132.5. The control unit 210 is arranged on the spindle drive unit 134. The protection unit 220 is arranged on the rocker 132, in particular in the region of the rocker joint 132.5. The control unit 210 is actuated by a spindle movement. The actuation is transmitted to the protection unit 220 via the coupling element 230. The protection unit 220 can then be moved into a protection position 306 in order to block the rocker joint 132.5 and thus limit a movement of the rocker elements 132.3, 132.4 relative to each other.

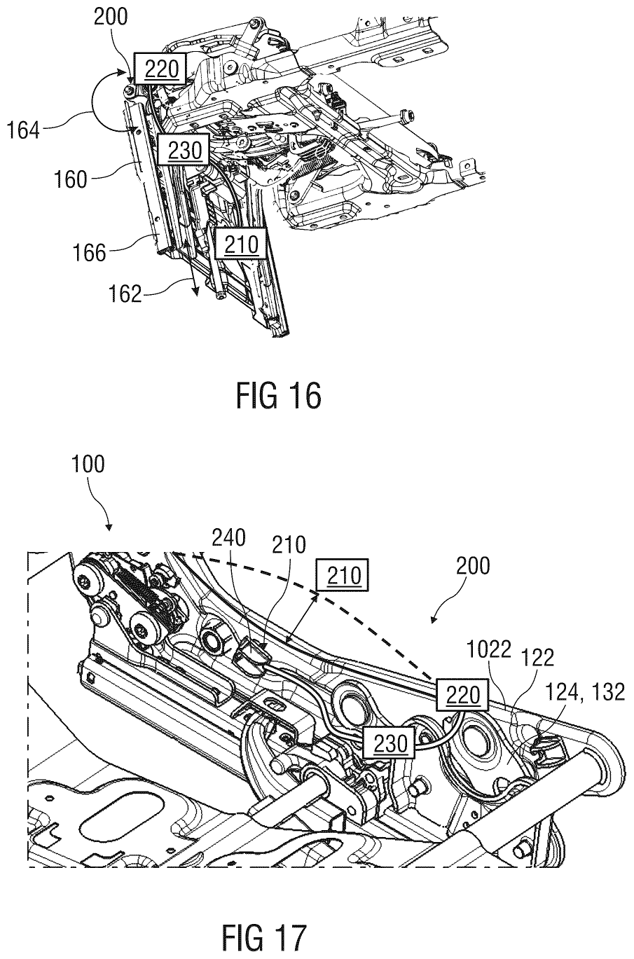

FIG. 16 shows schematically, in a perspective view, a leg support device 160 for a vehicle seat 100, wherein the leg support device 160 is provided with a protection module 200 according to the invention according to a fourth exemplary embodiment.

For example, the protection module 200 can be arranged in the region of a leg support device 160 of the vehicle seat 100 and configured to limit and/or block a leg support function of the leg support device 160. This can limit and/or block any unintentional further adjustment of the leg support device 160, for example, under load, relative to the seat part 102. Upon extension or a combined extension movement 162 with a pivoting movement 164 of a leg support element 166, the control unit 210 can be actuated. In an extended position, the control unit 210 can assume a control position 302 and actuate the protection unit 220. The protection unit 220 can then block and/or limit any further pivoting movement 164 about a leg support axis. The linear extension movement 162 of the leg support element 166 can limit and/or block the pivoting movement 164.

FIG. 17 shows schematically, in a perspective view, a vehicle seat 100 with a protection module 200 according to the invention according to a fifth exemplary embodiment.

The control unit 210 and the coupling element 230 can be actuated by a change in the distance between the control unit 210 and the protection unit 220. For example, the coupling element 230 can be actuated by a linear movement, for example, a linear displacement of the control unit 210 relative to the protection unit 220, for example, perpendicular to a protection axis 224 of the protection unit 220. In the represented exemplary embodiment, the control unit 210 consists of only one holding element 240.

The control unit 210 can be assigned to a structural part 120 to 126, in particular fastened thereto, which can deform and/or distort in the event of a crash, wherein a deformation and/or distortion of the structural part 120 to 126 causes a movement of the control unit 210 in the deformation direction and/or distortion direction. To prevent the structural part 120 to 126 from deforming and/or distorting further in the deformation direction and/or distortion direction, the protection unit 220 can be actuated by the movement transmission via the coupling element 230 and block a further movement in the deformation direction and/or distortion direction of the control unit 210 and thus of the structural part 120 to 126. In a further development, the protection unit 220 can additionally engage with a rocker 132 of a height adjuster and/or tilt adjuster of the seat 102 through the movement transmission via the coupling element 230, so that a movement of the rocker 132 relative to the structural part 120 to 126 is limited and/or blocked in the event of a crash. As a result, the rocker 132, which can be pivotably mounted on the structural part 120 to 126, for example, on a seat frame side part 1022, cannot buckle in the event of a crash.

The features disclosed in the above description, the claims and the drawings may be important both individually and in combination for the realization of the invention in its various embodiments.

Although the invention has been described in detail in the drawings and the preceding illustration, the illustrations are to be understood as illustrative and exemplary, and not restrictive. In particular, the choice of the proportions of the individual elements shown in the drawings is not to be interpreted as required or restrictive. Furthermore, the invention is in particular not limited to the exemplary embodiments explained. Further variants of the invention and their implementation will become apparent to the person skilled in the art from the preceding disclosure, the figures, and the claims, as long as the resulting subject matter falls within the scope defined by the claims. As seat functions 140a to 140c, at least one backrest adjustment function, one seat tilt adjustment function, one seat height adjustment function, and/or one seat length adjustment function can be limited and/or blocked.

Terms used in the claims such as “comprise,” “have”, “include”, “contain” and the like do not exclude further elements or steps. The use of the indefinite article does not exclude a multiplicity. A single device can perform the functions of several units or apparatuses mentioned in the claims.

### LIST OF REFERENCE SIGNS

100 Vehicle seat
102 Seat part
1020 Seat part frame
1022 Seat frame side part
104 Backrest
1040 Backrest frame
106 Fitting
108 Axis of rotation
110 Length adjustment apparatus
112 Rail arrangement
114 First rail element (upper rail)
116 Second rail element (lower rail)
120 First structural part
122 Second structural part
124 Third structural part
126 Fourth structural part
130 Tilt adjustment apparatus
132 Rocker
132.1 Locking contour
132.2 Outer contour
132.3, 132.4 Rocker element
132.5 Rocker joint
134 Spindle drive unit
140a to 140c Seat function
150 Easy-entry position
152 Design position
160 Leg support device
162 Extension movement
164 Pivoting movement
166 Leg support element
200 Protection module
210 Control unit
212 First coupling point
214 Control axis
216.1 to 216.7 Control element
218.1 Washer
218.2 Rotary shaft
218.3 Control lever support
218.31 Connecting leg
218.32 Connecting opening
218.4 Control lever
218.5 Spring element
218.6 Spacer bushing
218.7 Washer
220 Protection unit
222 Second coupling point
224 Protection axis
226.1 to 226.7 Protection element
228.1 Washer
228.2 Rotary shaft
228.3 Protection lever support
228.31 Guide opening
228.4 Spring element
228.5 Protection lever
228.51 Locking lug
228.52 Sliding contour
228.6 Spacer bushing
228.7 Washer
230 Coupling element
232 First end
234 Second end
236 Bowden cable
240 Holding element
242 Holding arm
244 Holding guide
250 Stop element
300 Starting position (protection unit)
302 Protection position
304 Starting position (control unit)
306 Control position
Ha First block height
Hb Second block height
L Length
x Longitudinal direction
y Transverse direction
z Vertical direction

What is claimed is:

1. An adjustable vehicle seat comprising:
a first structural part,
a second structural part movable relative to the first structural part and
at least one protection module for limiting and/or blocking movement between the two structural parts and/or a seat function of the vehicle seat in the event of a crash or during normal use,
wherein the protection module comprises at least one control unit, one protection unit, and one coupling element arranged between the control unit and the protection unit,
wherein the control unit is assigned to the first structural part and the protection unit is assigned to the second structural part,
wherein the coupling element couples the control unit and the protection unit so that a second movement of the control unit triggered by a first movement of the first structural part is transmitted to the protection unit and the second structural part.

2. The adjustable vehicle seat of claim 1, wherein the first movement of the first structural part actuates the control unit, wherein the coupling element exerts a tensile force on the protection unit and actuates the protection unit to limit and/or block a third movement of the second structural part relative to the first structural part.

3. The adjustable vehicle seat of claim 1, wherein in the event of a crash, the control unit is configured to be actuated by deformation and/or distortion of the first structural part and, in normal use, by an adjustment movement of the first structural part.

4. The adjustable vehicle seat of claim 1, wherein the control unit and the coupling element are configured to be actuated by a change in distance between the control unit and the protection unit and/or by rotation of the control unit about a control axis, wherein the protection unit is movable between an initial position and a protection position.

5. The adjustable vehicle seat of claim 1, wherein the protection module comprises a retrofittable and/or pre-assembled plug-in module.

6. The adjustable vehicle seat of claim 1, wherein the control unit comprises at least one first coupling point for connection to a first end of the coupling element.

7. The adjustable vehicle seat of claim 6, wherein the protection unit comprises at least one second coupling point for connection to a second end of the coupling element.

8. The adjustable vehicle seat of claim 1, wherein the control unit comprises a plurality of control elements and the protection unit comprises a plurality of protection elements.

9. The adjustable vehicle seat of claim 8, wherein individual control elements and individual protection elements are designed as identical parts.

10. The adjustable vehicle seat of claim 8, wherein the plurality of control elements is arranged coaxially on a control axis, wherein the control unit comprises a spring element and a control lever pivotably arranged on a rotary shaft.

11. The adjustable vehicle seat of claim 8, wherein the plurality of protection elements is arranged coaxially on a protection axis, wherein the protection unit comprises a spring element and a protection lever arranged to pivot on a rotating shaft.

12. The adjustable vehicle seat of claim 1, wherein the coupling element comprises a Bowden cable.

13. A protection module for limiting and/or blocking a movement between at least two structural parts and/or a seat function of a vehicle seat in the event of a crash or during normal use, comprising:
one control unit,
one protection unit and
one coupling element arranged between the control unit and the protection unit,
wherein the coupling element couples the control unit and the protection unit so that movement of the control unit is transmitted to the protection unit.

14. The protection module of claim 13, wherein the control unit and the coupling element can be actuated by a change in distance between the control unit and the protection unit and/or by a rotation of the control unit about a control axis, the protection unit being movable between a starting position and a protection position.

15. The protection module of claim 13, wherein the control unit comprises at least one first coupling point for connection to a first end of the coupling element.

16. The protection module of claim 15, wherein the protection unit comprises at least one second coupling point for connection to a second end of the coupling element.

17. The protection module of claim 13, wherein the control unit comprises a plurality of control elements and the protection unit comprises a multiplicity of protection elements.

18. The protection module of claim 17, wherein the plurality of control elements is arranged coaxially on a control axis, wherein the control unit comprises a spring element and a control lever pivotably arranged on a rotary shaft.

19. The protection module of claim 17, wherein the plurality of protection elements is arranged coaxially on a protection axis, wherein the protection unit comprises a spring element and a protection lever arranged to pivot on a rotating shaft.

20. The protection module of claim 13, wherein the coupling element comprises a Bowden cable.
